(19) United States
(12) Patent Application Publication
(10) Pub. No.: US 2025/0050224 A1
(43) Pub. Date: Feb. 13, 2025

(54) DYNAMIC MODERATION BASED ON SPEECH PATTERNS

(71) Applicant: SONY INTERACTIVE ENTERTAINMENT LLC, San Mateo, CA (US)

(72) Inventors: Nataliya Goji, San Mateo, CA (US); Michelle Nguyen, San Mateo, CA (US); Celeste Bean, San Mateo, CA (US); Kathleen Burns, San Mateo, CA (US); Jessica Chiang, San Mateo, CA (US)

(21) Appl. No.: 18/231,679

(22) Filed: Aug. 8, 2023

(51) Int. Cl. A63F 13/67; A63F 13/63; A63F 13/69; A63F 13/79

(52) U.S. Cl. CPC A63F 13/67; A63F 13/63; A63F 13/69; A63F 13/79

(57) ABSTRACT

Embodiments of the present invention include systems and methods for dynamically moderating gameplay content according to speech patterns of a user. The system may receive one or more audio segments set over a communication network from a user device, where the audio segments include recorded communications associated with a user of the user device. This may include monitoring a gameplay session of the user device, where one or more gameplay interactions within a virtual environment are detected in the gameplay session. Using a machine-learning model, one or more inferences regarding the user may be generated based upon the audio segments and the detected gameplay interactions. A set of moderation parameters, based on the user inferences, may be generated by the machine-learning model. The system may modify content within the virtual environment of the gameplay session according to the set of moderation parameters.

### BACKGROUND OF THE INVENTION

### 1. Field of the Invention

The present invention generally related to content moderation. More specifically, the present invention relates to dynamic content moderation according to speech patterns of a user.

### 2. Description of the Related Art

Presently available content moderation systems may include moderation tools used by human content moderators to define and implement a series of controls or limitations for gameplay. For example, the controls or limitations allow users (or parents, guardians, or supervisors of the users, as well as community members) to set limits on the type of content presented to the user or group of users (e.g., children under 12). For example, controls or limitations may be applicable to block profane, obscene, or culturally offensive language (e.g., key words and phrases), violence/gore (e.g., images or video), or any combination thereof. The controls or limitations may apply restrictions to particular game titles, game ratings (e.g., “T,” “M,” etc.), and/or game types so as to limit the ability of the user to initiate a gameplay session associated with a particular game title or a game title with a particular rating. In some instances, the controls or limitations may limit language and/or violence/gore in a binary manner. For example, the controls or limitations are switched “on” or “off.”

Many users, however—particularly users new to gaming generally, a game title, gaming community, or gaming platform—do not necessarily share user information (e.g., age, cultural norms) that can be used to determine whether moderation is necessary or appropriate. Moreover, users may differ in terms of the content types they wish to be presented with and the content types they wish to avoid (or that their parents, etc., wish for them to avoid). As a result, it may be difficult to apply controls or limitations that universally apply to all game titles due to the diversity in gaming content and the lack of information regarding a user (e.g., user age, mood, changing preferences, etc.).

There is, therefore, a need in the art for an improved systems and methods of dynamic moderation of gameplay content.

### SUMMARY OF THE CLAIMED INVENTION

Embodiments of the present invention include systems and methods for dynamically moderating gameplay content according to speech patterns of a user. The system may receive one or more audio segments set over a communication network from a user device, where the audio segments include recorded communications associated with a user of the user device. This may include monitoring a gameplay session of the user device, where one or more gameplay interactions within a virtual environment are detected in the gameplay session. Using a machine-learning model, one or more inferences regarding the user may be generated based upon the audio segments and the detected gameplay interactions. A set of moderation parameters, based on the user inferences, may be generated by the machine-learning model. The system may modify content within the virtual environment of the gameplay session according to the set of moderation parameters.

### BRIEF DESCRIPTION OF THE DRAWINGS

FIG. 1 illustrates an exemplary network environment in which a system for dynamic content moderation may be implemented.

FIG. 2 illustrates an exemplary content moderation processor that is trained to generating moderation parameters in accordance with an embodiment.

FIG. 3 is a flowchart illustrating an exemplary method for moderating gameplay content at a gameplay server in accordance with an embodiment.

FIG. 4A is a flowchart illustrating an exemplary method for dynamic moderation of gameplay content in accordance with an embodiment.

FIG. 4B illustrates an exemplary user interface displaying a gameplay session in accordance with an embodiment.

FIG. 4C illustrates an exemplary moderated user interface displaying a moderated gameplay session in accordance with an embodiment.

FIG. 4D illustrates an exemplary chat interface displaying a chat-based communication between one or more user devices.

FIG. 4E illustrates an exemplary moderated chat interface displaying a moderated chat-based communication between one or more user devices.

FIG. 5 illustrates a block diagram of an example electronic entertainment system in accordance with an embodiment.

### DETAILED DESCRIPTION

Embodiments of the present invention include systems and methods for dynamically moderating gameplay content according to speech patterns of a user. The system may receive one or more audio segments set over a communication network from a user device, where the audio segments include recorded communications associated with a user of the user device. This may include monitoring a gameplay session of the user device, where one or more gameplay interactions within a virtual environment are detected in the gameplay session. Using a machine-learning model, one or more inferences regarding the user may be generated based upon the audio segments and the detected gameplay interactions. A set of moderation parameters, based on the user inferences, may be generated by the machine-learning model. The system may modify content within the virtual environment of the gameplay session according to the set of moderation parameters.

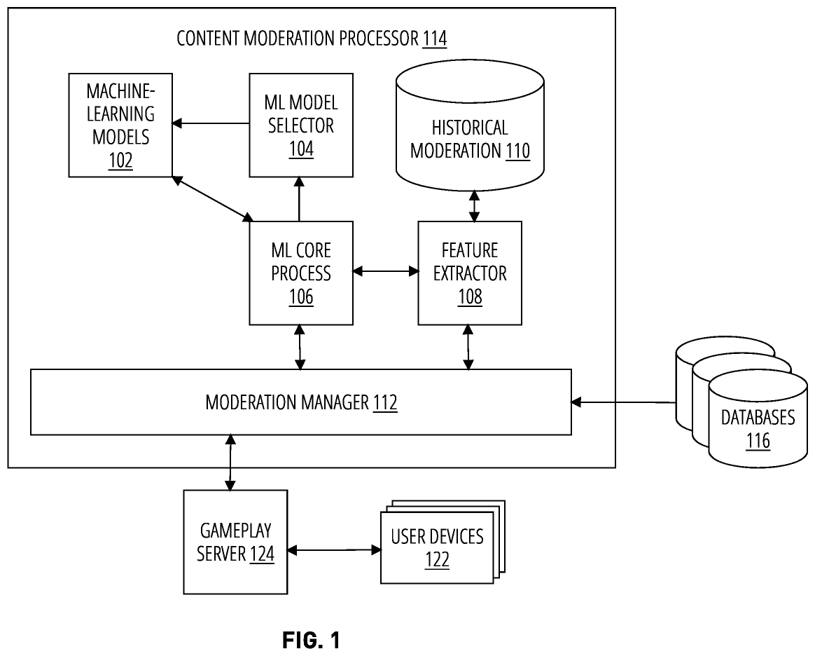

FIG. 1 illustrates an exemplary network environment in which a system for dynamic content moderation may be implemented. Such a network environment may include a variety of different networked systems and system devices, including custom moderation processor 114, databases 116, user devices 122, and gameplay manager 124. The devices may communicate with each other directly or through one or more intermediary networks (e.g., local area network, wide area network, Internet, virtual private networks, etc.).

Content moderation processor 114 may facilitate the moderation of gameplay content (e.g., profanity, violence/gore, graphic displays, vocabulary, etc.) within a gameplay session conducted by a user device (e.g., a gaming system, laptop, desktop, smartphone, etc.) associated with a user. As illustrated, custom moderation processor 114 may include machine learning models 102, ML model selector 104, ML core process 106, feature extractor 108, historical moderation parameters 110, and moderation manager 112. Such components of custom moderation processor 114 may be executable by one or more processing devices (e.g., computing devices, mobile devices, servers, databases, etc.) configured to operated together to provide the services of custom content generator 114. The components 102-112 and processing devices may operate within a same local network (e.g., such as a local area network, wide area network, mesh network, etc.) or may be distributed processing devices (e.g., such as a cloud network, distributed processing network, or the like).

User devices 122 may send a request to initiate a new gameplay session to gameplay server 124. The request may include a game title and a type of gameplay session (e.g., open play, story mode, etc.). The request may initiate content moderation processor 114. The request may also include other parameters, such as user profile data (associated with user devices 122, such as, but not limited to, user characteristics, user demographics, user gameplay history, location data, etc.), user preferences, social contact, prior moderation sessions associated with the user, or combinations thereof.

Content moderation processor 114 may connect to gameplay server 124 and instantiate a new moderation session for user devices 122. The moderation session may be instantiated automatically according to one or more settings associated with the user profile associated with the user. In some examples, the user profile may be modified to modify the one or more settings. Moreover, the user profile may be modified to indicate that the moderation session only be instantiated with explicit instructions from user devices 122.

Over the duration of the moderation session, the content moderation processor 114, using ML core process 106, may provision one or more machine-learning models to enable any of the extended functionality. The one or more machine-learning models may be configured to provide natural language processing (e.g., such as a large language model, bi-directional transformers, zero/few shot learners, deep neural networks, etc.), content generation (e.g., using large language models, deep neural networks, generative adversarial networks, etc.), single variate or multivariate classifiers (e.g., k-nearest neighbors, random forest, logarithmic regression, decision trees, support vector machines, gradient decent, etc.), image processing (e.g., using deep neural networks, convolutional neural networks, etc.), sequenced data processors (e.g., such as recurrent neural networks, etc. capable of processing datasets organized according to a taxonomic sequence), and/or the like.

Such machine learning techniques may further be applied to game data and associated content, which may be captured during gameplay sessions of different users and user devices 122. Such game data may include not only information regarding the game titles being played, but also data regarding the audiovisual content presented therein, user profiles, online communications, behaviors, etc., associated with the gameplay session. Such game data may be monitored and stored in memory as object or activity files, which may be used for supervised and unsupervised learning whereby a model may be trained to recognize patterns between certain game/user data and user characteristics or classification (e.g., used to identify relevant moderation parameters). In some implementations, sets of the object files or activity files may be labeled in accordance with any combination of game metadata and user feedback, including user feedback associated with moderated and unmoderated content.

The machine-learning models may be configured to process natural language communications (e.g., such as verbal, textual, etc.) in conjunction with available user data to generate moderated or otherwise modified gameplay content according to one or more moderation parameters (e.g., utilizing input from the user, user characteristics, prior moderation sessions, moderations sessions associated with the game title, data pertaining to one or more additional users, gameplay server 124, third-party databases 116, etc.), identify gameplay content to be moderated in a gameplay session (e.g., violence/gore, mature content, obscenity, graphic material, complexity, horror/scare content, etc.), modify behavior of non-playable characters (NPC) (e.g., modify language/speech, dialogue, behavior, appearance, interactions with a character associated with user devices 122, etc.), modify the virtual environment (e.g., change background noises/music, modifying timeline of a game story, modifying colors, modifying design of game setting, etc.), increase/decrease difficulty of the gameplay session (e.g., add/remove elements of the gameplay session, increase the necessary damage to defeat one or more opponents within the gameplay session, etc.), and/or the like. Different machine learning models 102 may be trained using different types of data input, which may be specific to the user, the user demographic, associated game or other interactive content title(s) and genres thereof, social contacts, etc. Using the selected data inputs, therefore, the machine learning models 102 may be trained to identify information regarding a particular user and identify content moderation parameters that may be specifically relevant to the user (e.g., female 10-year old child that plays dancing games versus male 31-year old adult that plays horror-based games).

ML model selector 104 may be executable to select one or more machine learning models 102 to apply to a received request or query from user device 122. Such selection by ML model selector 104 may include selection of one or more machine learning models 102, generating one or more new machine learning models, or training one or more machine learning model 102 based on user data or associated game data to apply to the request from the user device 122.

Content moderation processor 114 may receive gameplay content (including data regarding communications or in-game actions taken by other players) associated with a gameplay session of a game title from gameplay server 124 and user input (e.g., audio segments, one or more actions conducted over the duration of the gameplay session, data associated with a user profile associated with a user (e.g., age, demographic, etc), decisions made while completing actions within the gameplay session, success rate over the duration of the gameplay session, historical moderation parameters associated with the user), any combination thereof, or the like). The gameplay content may comprise dialogue, themes, images, standard game title difficulty (e.g., the game title difficulty with little-to-no modifications), NPC characteristics, etc., virtual gameplay session environment (e.g., setting, design, music, sound effects, etc.), any combination thereof, or the like. Content moderation processor 114 may pass the gameplay content and user input received from the gameplay server 124 to ML core process 106 to process the gameplay content and user input using the one or more machine-learning models. ML core process 106 may monitor one or more machine-learning models configured to provide the services of the content moderation processor 114. ML core process 106 may train new machine-learning models, retrain (or reinforce) existing machine-learning models, delete machine-learning models, and/or the like. Since ML core process 106 manages the operations of a variety of machine-learning models, each request to ML core process 106 may include an identification of a particular machine-learning model, a requested output, or the like to enable ML core process 106 to route the request to an appropriate machine-learning model or instantiate and train a new machine-learning model. Alternatively, ML core process 106 may analyze data to be processed that is included in the request to select an appropriate machine-learning model configured to process data of that type.

If ML core process 106 cannot identify a trained machine-learning model configured to process the request, then ML core process 106 may instantiate and train one or more machine-learning models configured to process the request. Machine-learning models may be trained to process a particular input and/or generate a particular output. ML core process 106 may instantiate and train machine-learning models based on the particular data to be processed and/or the particular output requested. For example, user sentiment analysis (e.g., user intent, etc.) may be determined a natural language processor and/or a classifier while image processing may be performed using a convolutional neural network.

ML core process 106 may select one or more machine-learning models based on characteristics of the data to be processed and/or the output expected. ML core process 106 may then use feature extractor 108 to generate training datasets for the new machine-learning models (e.g., other than those models configured to perform features extraction such as some deep learning networks, etc.). Feature extractor 108 may define training dataset using historical moderation 110. Historical moderation 110 may store moderation parameters and/or gameplay content from previous moderation sessions. In some instances, the previous moderation sessions may be associated with one or more additional user devices not associated with the user of user devices 122. Previous moderation sessions may include manually and/or procedurally generated data generated for use in training machine-learning models. Historical moderation 110 may not store any information associated with particular users. Alternatively, historical moderation 110 may store features extracted from moderation sessions involving the user of user devices 122 and/or other users.

Feature extractor 108 may extract features based on the type of model to be trained and the type of training to be performed (e.g., supervised, unsupervised, etc.) from historical moderation 110. Feature extractor 108 may include a search function (e.g., such as procedural search, Boolean search, natural language search, large language model assisted search, or the like) to enable ML core process 106, an administrator, or the like to search for particular datasets within historical moderation 110 to improve the data selection for the training datasets. Feature extractor 108 may aggregate the extracted features into one or more training datasets usable to train a respective machine-learning model of the one or more machine-learning models. The training datasets may include training datasets for training the machine-learning model, training datasets to test a trained machine-learning model, and/or the like. The one or more training datasets may be passed to ML core process 106, which may manage the training process.

Feature extractor 108 may pass the one or more training datasets to ML core process 106 and ML core process 106 may initiate a training phase for the one or more machine-learning models. The one or more machine-learning models may be trained using supervised learning, unsupervised learning, self-supervised learning, or the like. The one or more machine-learning models may be trained for a predetermined time interval, a predetermined quantity of iterations, until one or more target accuracy metrics have exceeded a corresponding threshold (e.g., accuracy, precision, area under the curve, logarithmic loss, F1 score, weighted human disagreement rate, cross entropy, mean absolute error, mean square error, etc.), user input, combinations thereof, or the like. Once trained, ML core process 106 may validate and/or test the trained machine-learning models using additional training datasets. The machine-learning models may also be trained at runtime using reinforcement learning.

Once the machine-learning models are trained, ML core process 106 may manage the operation of the one or more machine learning models (stored with other machine-learning models in machine-learning models 102) during runtime. ML core process 106 may direct feature extractor 108 to define feature vectors from received data (e.g., such as audio segments from user devices 122, interactions with the gameplay session from user devices 122 (e.g., success rate over the duration of the gameplay session, interactions with NPC, etc.), gameplay content received from gameplay server 124, etc.). In some instances, ML core process 106 may facilitate generation of a feature vector each time there is a change in a communication channel (e.g., an audio segment is transmitted over the communication channel from user devices 122, a new communication associated with the gameplay session is received (e.g., a response to a NPC), data is received from gameplay server 124 pertaining to the game title, and/or the like). ML core process 106 may continually execute the one or more machine-learning models to generate corresponding output. ML core process 106 may evaluate the outputs to determine whether to manipulate a user interface (e.g., and/or a virtual reality interface) of the moderation session based on the output (e.g., modify the gameplay content of the gameplay session).

For example, ML core process 106 may detect a new audio segment from user devices 122 over the moderation session. ML core process 106 may execute a machine-learning model (e.g., such as a recurrent neural network) to process the audio segment to determine the words with the audio segment (if any) and a sentiment (e.g., a predicted meaning of the individual words or the words as a whole). ML core process 106 may execute another machine-learning model (e.g., such as a classifier, a large language model and/or transformer, a generative adversarial network, etc.), to generate one or more moderation parameters corresponding to the words and/or sentiment that can be utilized to modify the gameplay content. For instance, the words may include reactions to an event within the gameplay session, response to one or more NPC, response to one or more other user devices participating in the gameplay session, off-hand comments pertaining to the gameplay session, etc. The other machine-learning model may process the words and sentiment to generate moderation parameters applicable to the gameplay content such as one or more modifications to the gameplay sessions such as an adjustment of difficulty level, adjustment of level of maturity of dialogue, appearance of gameplay content (e.g., style of buildings, style of dress, etc.), adjustment of NPC interactions, adjustment of violence/gore, etc.

ML core process 106 may direct feature extractor 108 to define other feature vectors to process other data using machine-learning models of machine-learning models 102 in parallel with the aforementioned machine-learning models to provide other resources of content moderation processor 114. ML core process 106 may execute any number of machine-learning models in parallel to provide the functionality of a customization session.

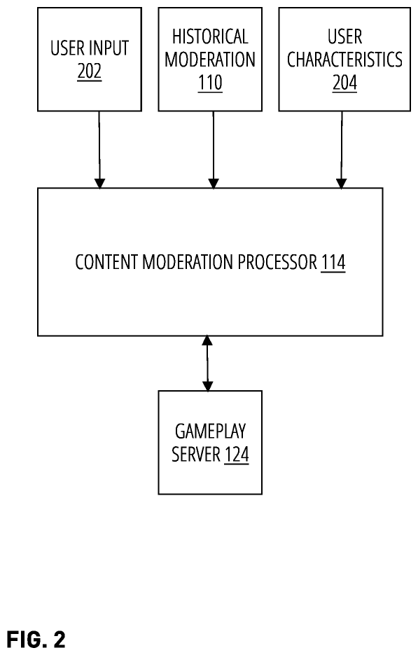

FIG. 2 illustrates an exemplary content moderation processor that is trained to generating moderation parameters in accordance with an embodiment. The content moderation processor 114 may receive input from one or more data sources, including, but not limited to, user input 202, historical moderation 110, and/or user characteristics 204. Content moderation processor 114 may also receive input or send output to or from gameplay server 124.

A user device may initiate a moderation session by requesting a gameplay session associated with a game title. Gameplay server 124 may receive the request from the user device, and may instantiate a moderation session via content moderation processor 114 to operate in parallel with the gameplay session. Over the duration of the gameplay session, content moderation processor 114 may receive one or more elements of data pertaining to the user device. The elements of data may be audio segments received over the duration of the gameplay session, data associated with a user profile associated with the user device, moderation parameters associated with a prior gameplay session, a set of one or more actions taken over the duration of the gameplay session (e.g., an interaction with an NPC, failure to beat an opponent, decisions made, etc.), any combination thereof, or the like.

For example, content moderation processor 114 may receive audio input from user input 202. User input 202 may include audio segments received via the user device. Over the duration of the gameplay session, the user device may be prompted by gameplay content to participate in conversation. In other examples, the user associated with the user device may have a brief verbal outburst of frustration, joy, etc. The brief outburst may be utilized as an audio segment and may be input into content moderation processor 114. In other examples, content moderation processor 114 may prompt the user device for one or more audio segments. Content moderation processor 114 may output questions and/or prompts to the user device and require that the user device answer via audio.

Content moderation processor 114 may also use non-audio input from user input 202. For example, over the duration of a gameplay session, the user device may be presented with one or more choices. Content moderation processor 114 may receive the decision-making of the user device as input to generate one or more user inferences and/or one or more moderation parameters. For example, content moderation processor 114 may receive interactions between the user device and NPC, failure/success in beating an opponent, level of risk-aversion, any combination thereof, or the like.

Content moderation processor 114 may also receive data from a historical moderation 110 database. Historical moderation 110 may include gameplay content, one or more moderation parameters, user data (e.g., user input, user characteristics, user profile, etc.), or any additional data pertaining to one or more prior moderation sessions. The one or more prior moderation sessions may be associated with the user device. In some examples, the one or more prior moderation sessions may be associated with one or more other user devices. Content moderation processor 114 may receive the data pertaining to the one or more prior moderation sessions and determine if any of the data is applicable to the present application session. For example, historical moderation 110 may indicate that content moderation processor 114 reduced the profane language for other user devices associated with users similarly situated to the user. Accordingly, content moderation processor 114 may reduce the profane language over the duration of the present moderation session.

Content moderation processor 114 may receive data from user characteristics 204. User characteristics 204 may comprise data associated with a user profile of the user. The user profile may contain demographic data, age data, geographic locality data, gaming history, language settings, culture, diction, any combination thereof, or the like. Content moderation processor 114 may utilize data from user characteristics 204 to generate one or more user inferences and/or one or more moderation parameters.

Content moderation processor 114 may also receive gameplay content from gameplay server 124. The gameplay content may include the visuals, graphics, themes, audio, and/or other elements of the gameplay session that may be modified by content moderation processor 114. Content moderation processor 114 may enable one or more machine-learning models (e.g., deep neural networks, convolutional neural networks, etc.) trained to process visual and audio data to determine gameplay content that may be moderated (e.g., scenes of gore/violence, obscene content, mature language, manner of dress, etc.).

Content moderation processor 114 may provision one or more machine-learning models configured to provide natural language processing (e.g., such as a large language model, bi-directional transformers, zero/few shot learners, deep neural networks, etc.), content generation (e.g., using large language models, deep neural networks, generative adversarial networks, etc.), single variate or multivariate classifiers (e.g., k-nearest neighbors, random forest, logarithmic regression, decision trees, support vector machines, gradient decent, etc.), image processing (e.g., using deep neural networks, convolutional neural networks, etc.), sequenced data processors (e.g., such as recurrent neural networks, etc. capable of processing datasets organized according to a taxonomic sequence), and/or the like. Content moderation processor 114 may provision more than one machine-learning model to perform the functionality disclosed herein (e.g., generate user inferences, generate moderation parameters, modify gameplay content, etc.). For example, a first machine-learning model may receive gameplay content from gameplay server 124 and identify gameplay content that may be moderated. Moreover, a second machine-learning model may identify user inferences according to user input 202, historical moderation 110, and/or user characteristics 204. Finally, a third machine-learning model may generate one or more moderation parameters based on the user inferences and modify the gameplay content. In some examples, content moderation processor 114 may only employ one machine-learning model to perform the functionality disclosed herein. For example, the first machine-learning model may receive gameplay data, identify user inferences, and generate moderation parameters used to modify the gameplay content.

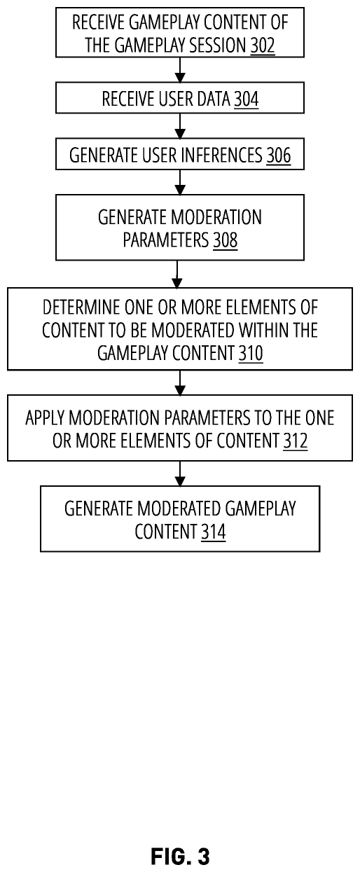

FIG. 3 is a flowchart illustrating an exemplary method for moderating gameplay content at a gameplay server in accordance with an embodiment. Although the example flowchart depicts a particular sequence of operations, the sequence may be altered without departing from the scope of the present disclosure. For example, some of the operations depicted may be performed in parallel or in a different sequence that does not materially affect the function of the flowchart. In other examples, different components of an example device or system that implements the flowchart may perform functions at substantially the same time or in a specific sequence.

According to some examples, the method includes receiving gameplay content of the gameplay session at block 302. A user device associated with a user may request to initiate a gameplay session, which may initiate a concurrent moderation session. Accordingly, a content moderation processor (e.g., the content moderation processor 114 described in FIGS. 1 and 2) may receive gameplay content from a gameplay server (e.g., the gameplay server 124 described in FIGS. 1 and 2). The gameplay content may be associated with a particular game title and may comprise dialogue, themes, images, standard game difficulty, NPC characteristics, music, sound effects, any combination thereof, or the like. The gameplay content and the game title may be identified in the request from the user device. In some examples, the moderation session may not initiate automatically according to one or more user device settings. The user device may manually initiate the moderation session through a second request.

According to some examples, the method includes receiving user data at block 304. The user data may include data gathered over the duration of a gameplay session (e.g., audio segments, interactions with gameplay content, decisions made, text/word outputs, etc.), data pertaining to one or more prior moderation sessions (e.g., prior moderation sessions associated with the user or one or more other users), user profile data (e.g., user demographics, age, geographic location, region, dialect, language, preferred diction, education level, etc.), any combination thereof, or the like. The content moderation processor may query for user data after a time period or may receive user data in real-time. For example, an action taken by the user device within the gameplay session may be received by the content moderation processor in real-time. In another example, the content moderation processor may query for changes in the user data every 0.5 seconds, after the completion of a level, after one or more checkpoints, etc.

According to some examples, the method includes generating user inferences at block 306. The user inferences may be pertaining to one or more present qualities of the user based on the user data. The user inferences may include inferences about a mood of the user (e.g., anxious, energetic, frustrated, content, etc.), age/maturity level of the user, regional dialect and/or language of the user, education level of the user, any combination thereof, or the like. In some examples, the user inferences may be generated and applied to all subsequent gameplay sessions and/or moderation sessions for a duration of time (e.g., a week, a month, a year, etc.). In some instances, a portion of the user inferences may be re-generated at a more frequent rate (e.g., mood of the user) while a portion of the user inferences may be re-generated at a less frequent rate (e.g., age/maturity, regional dialect, etc.).

In some examples, the content moderation processor may provision one or more machine-learning models configured to provide natural language processing (e.g., such as a large language model, bi-directional transformers, zero/few shot learners, deep neural networks, etc.), content generation (e.g., using large language models, deep neural networks, generative adversarial networks, etc.), single variate or multivariate classifiers (e.g., k-nearest neighbors, random forest, logarithmic regression, decision trees, support vector machines, gradient decent, etc.), image processing (e.g., using deep neural networks, convolutional neural networks, etc.), sequenced data processors (e.g., such as recurrent neural networks, etc. capable of processing datasets organized according to a taxonomic sequence), and/or the like. The one or more machine-learning models may receive user data and generate one or more user inferences. For example, a first machine-learning model may receive user data and infer an age, demographic, geographic region, and mood of the user.

According to some examples, the method includes generating moderation parameters at block 308. The moderation parameters may be modifications customized to the user that are applicable to one or more elements of gameplay content. For example, a moderation parameter may be applicable to the manner of dress of NPC. In some examples, moderation parameters may be applied to modify the gameplay content to be more age-appropriate for the user. In some examples, the moderation parameters may be applied to elicit a particular response out of the user. For example, moderation parameters may be applied to NPC or opponents in the game title to make them more unlikeable by the user. In some other examples, the gameplay content may be modified to alter the mood of the user, such as adding calming music if the user is demonstrating signs of anxiousness. The moderation parameters may be applied to one or more gameplay sessions and/or moderation sessions. In some examples, the one or more moderation parameters may be directed at user mimicry of the user. For example, the one or more moderation parameters may indicate that a hair color of an NPC be blonde, like the user. In another example, the one or more moderation parameters may indicate that NPC should speak in a manner similar to the user (e.g., use the same slang, use the same tone of voice, have the same sense of humor, etc.). In some other examples, the one or more moderation parameters may be directed at gameplay difficulty. For example, if the user inferences indicate that the user is struggling with a particular task or challenge over the gameplay session, the one or more moderation parameters may indicate a change in difficulty (e.g., give the user's character extra “lives” within the game, decrease strength of an opponent, give a hint to the user, etc.). In some examples, the moderation parameters are re-generated at a more frequent rate (e.g., moderation parameters directed at altering the mood of the user) as opposed to other moderation parameters (e.g., moderation parameters directed at modifying gameplay content to make it age-appropriate).

In some examples, the content moderation processor may provision one or more machine-learning models to generate the moderation parameters (e.g., the first machine-learning model). The one or more machine-learning models may receive one or more user inferences and generate one or more moderation parameters according to the game title. For example, if a gameplay session of a game title may contain large amounts of violence and gore, the first machine-learning model may generate one or more moderation parameters directed at decreasing the amount of blood shown, decreasing the severity of injuries shown, etc. As another example, if a gameplay session of a game title contains profane language by NPC, the first machine-learning model may generate one or more moderation parameters directed at eliminating profane language.

According to some examples, the method includes determining one or more elements of content to be moderated within the gameplay content at block 310. The content moderation processor may receive gameplay content associated with the gameplay session of the game title from a gameplay server (e.g., gameplay server 124). The content moderation processor may provision one or more machine-learning models (e.g., the first machine-learning model) to determine elements of the gameplay content that may be modified according to the one or more moderation parameters. The content moderation processor may receive audio input, video input, anticipated interactions (e.g., interactions with NPC, an opponent, tasks, missions, etc.), game themes, time period, game design style, any combination thereof, or the like. For example, the first machine-learning model may receive gameplay content of a particular game title and identify one or more elements of gameplay content that may be modified.

In some examples, the one or more machine-learning models provisioned by the content moderation processor may receive input beyond the gameplay content. For example, the first machine-learning model may receive historical data pertaining to modified gameplay content in prior modification sessions. The first machine-learning model may reference the modified gameplay content while determining one or more elements of gameplay content to be moderated.

According to some examples, the method includes applying moderation parameters to the one or more elements of content at block 312. The content moderation processor may apply the moderation parameters to the one or more elements of gameplay content to be modified. The content moderation processor may provision a machine-learning model capable of content generation (e.g., the first machine-learning model) to modify the one or more elements of gameplay content. For example, the first machine-learning model may apply a moderation parameter (e.g., reduction of violence/gore) to one or more elements of gameplay content (e.g., a graphic violent image) and modify the one or more elements of gameplay content (e.g., reducing the visible blood and/or removing a graphic image from the user interface).

According to some examples, the method includes generating moderated gameplay content at block 314. The content moderation processor may generate moderated gameplay content and output the moderated gameplay content to the gameplay server (e.g., gameplay server 124 of FIGS. 1 and 2). The gameplay server may output the moderated gameplay content to the user device for display on a user interface. In some examples, the user interface may be a virtual reality interface.

In some examples, the user device may provide feedback to the content moderation processor. If, upon receipt of the moderated gameplay content, the user associated with the user device is not satisfied with the one or more user parameters, one or more moderation parameters, and/or the modified gameplay content, the user device may manually manipulate the system to generate preferred results. For example, if the user device wants to see more violence/gore, but a moderation parameter has limited the violence/gore, the user device may indicate to the content moderation processor that the moderation parameter should be updated. The user device may also modify the one or more moderation parameters according to the one or more user inferences. For example, if a user inference indicates that a user speaks Spanish, but the user wants to learn Portuguese, the user may modify the user inference applicable to language, thereby modifying the one or more moderation parameters to dictate that gameplay sessions be conducted in Portuguese.

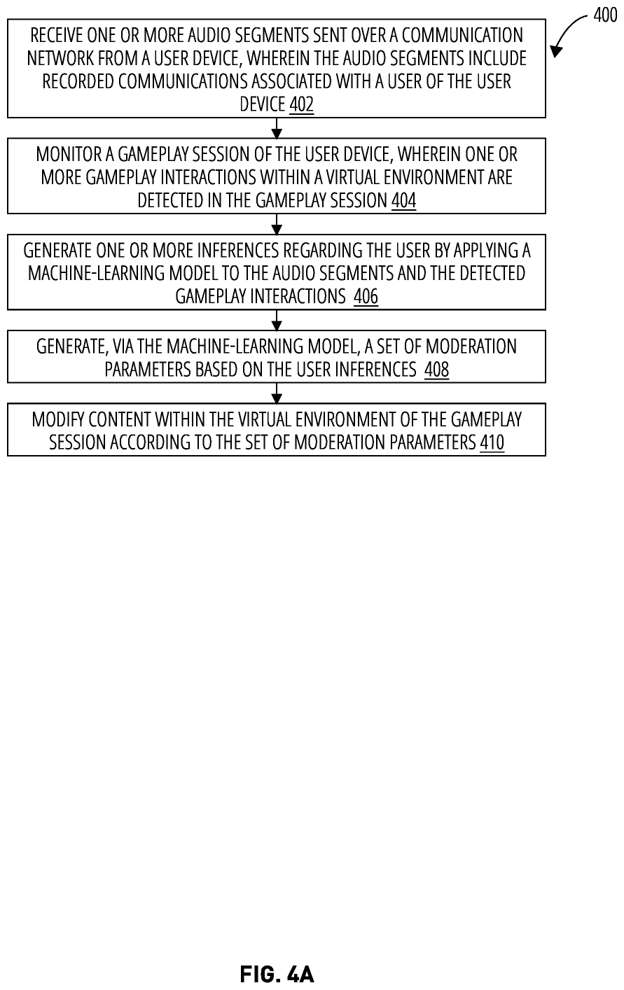

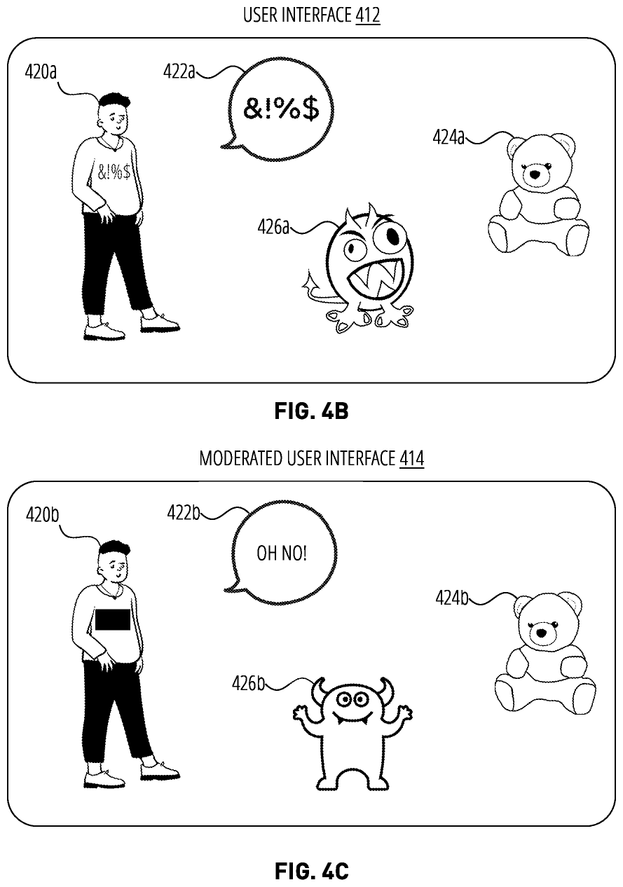

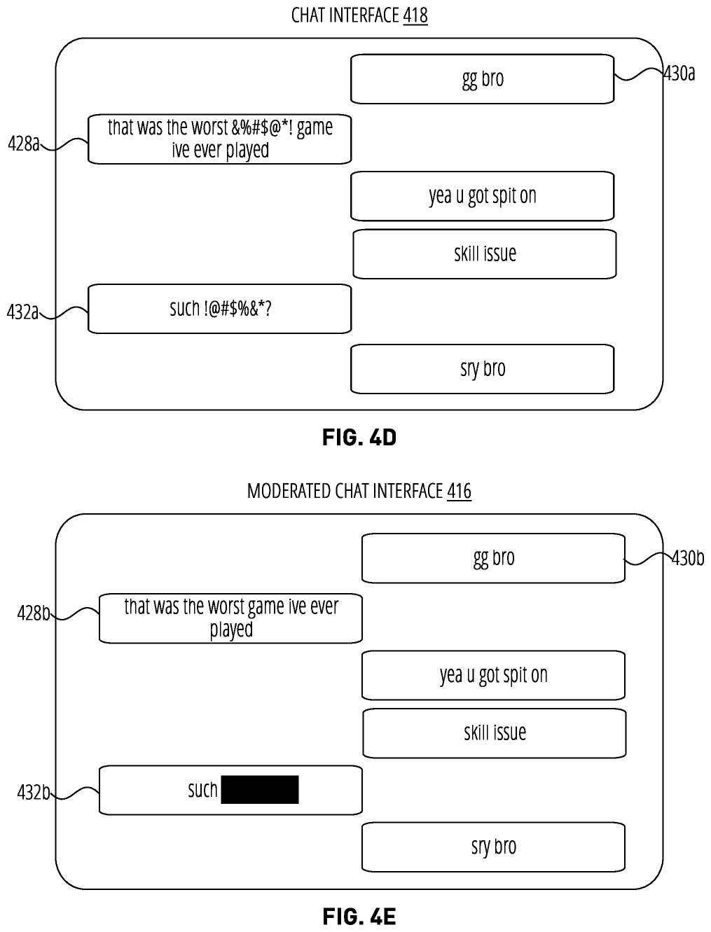

FIG. 4A is a flowchart illustrating an exemplary method for dynamic moderation of gameplay content in accordance with an embodiment. Although the example routine 400 depicts a particular sequence of operations, the sequence may be altered without departing from the scope of the present disclosure. For example, some of the operations depicted may be performed in parallel or in a different sequence that does not materially affect the function of the routine 400. In other examples, different components of an example device or system that implements the routine 400 may perform functions at substantially the same time or in a specific sequence.

According to some examples, the method includes receiving one or more audio segments sent over a communication network from a user device, wherein the audio segments include recorded communications associated with a user of the user device at block 402. A content moderation processor (e.g., content moderation processor 114 described in FIGS. 1 and 2) may receive audio segments from the user device associated with the user. The audio segments may be received over the duration of a gameplay session and/or a moderation session, wherein the moderation session may be running concurrently with the gameplay session. Over the duration of the gameplay session, the user device may be prompted to participated in conversation. In other examples, the user associated with the user device may have a brief verbal outburst of frustration, joy, etc. The brief outburst may be utilized as an audio segment and may be input into the content moderation processor. In other examples, the content moderation processor may prompt the user device for one or more audio segments. The content moderation processor may output questions and/or prompts to the user device and require that the user device answer via audio segment.

According to some examples, the method includes monitoring a gameplay session of the user device, wherein one or more gameplay interactions within a virtual environment are detected in the gameplay session at block 404. Content moderation processor may receive gameplay interactions (e.g., decisions made by the user, interactions with NPC, success/failure to complete certain tasks, etc.) from a gameplay server (e.g., gameplay server 124 described in FIGS. 1 and 2). The gameplay interactions may comprise conversational interactions, physical interactions, or mental interactions (e.g., decision making) with the virtual environment.

According to some examples, the method includes generating one or more inferences regarding the user by applying a machine-learning model to the audio segments and the detected gameplay interactions at block 406. Content moderation processor may provision one or more machine-learning models configured to provide natural language processing (e.g., such as a large language model, bi-directional transformers, zero/few shot learners, deep neural networks, etc.), content generation (e.g., using large language models, deep neural networks, generative adversarial networks, etc.), single variate or multivariate classifiers (e.g., k-nearest neighbors, random forest, logarithmic regression, decision trees, support vector machines, gradient decent, etc.), image processing (e.g., using deep neural networks, convolutional neural networks, etc.), sequenced data processors (e.g., such as recurrent neural networks, etc. capable of processing datasets organized according to a taxonomic sequence), and/or the like. The one or more machine-learning models may be trained to generate one or more inferences regarding the user based upon the audio segments and the gameplay interactions.

The one or more inferences may be pertaining to one or more physical characteristics of the user (e.g., age, demographic, geographic location, etc.) and/or one or more mental characteristics of the user (e.g., maturity, education level, emotional state, mental state, mood, language/dialect spoken, etc.). For example, a first machine-learning model may generate an inference pertaining to a mood of the user based on a tone, volume, content, and/or frequency of an audio segment associated with the user. As another example, the first machine-learning model may generate an inference pertaining to an age of the user based on the slang, tone, and/or grammatical errors present in an audio segment associated with a user.

According to some examples, the method includes generating, via the machine-learning model, a set of moderation parameters based on the user inferences at block 408. The moderation parameters may be modifications customized to the user that are applicable to gameplay content within the gameplay session. For example, one or more moderation parameters may be applicable to the manner of dress, manner of speech, and/or manner of behavior of NPC. In some examples, moderation parameters may be applied to modify the gameplay content to be more age-appropriate for the user. In some examples, the moderation parameters may be applied to elicit a particular response out of the user (e.g., alter the user's emotional state, mental state, energy level, etc.). For example, moderation parameters may be applied to NPC or opponents in the game title to make them more unlikeable by the user. In some other examples, the gameplay content may be modified to alter the mood of the user, such as adding calming music if the user is demonstrating signs of anxiousness. The moderation parameters may be stored and applied to one or more gameplay sessions.

In some examples, the content moderation processor may provision one or more machine-learning models to generate the moderation parameters (e.g., the first machine-learning model). The one or more machine-learning models may receive one or more user inferences and generate one or more moderation parameters according to the game title. For example, if a gameplay session of a game title may contain large amounts of violence and gore, the first machine-learning model may generate one or more moderation parameters directed at decreasing the amount of blood shown, decreasing the severity of injuries shown, etc. As another example, if a gameplay session of a game title contains profane language by NPC, the first machine-learning model may generate one or more moderation parameters directed at eliminating profane language.

According to some examples, the method includes modifying content within the virtual environment of the gameplay session according to the set of moderation parameters at block 410. The content moderation processor may receive gameplay content associated with the gameplay session of the game title from a gameplay server (e.g., gameplay server 124). The content moderation processor may provision one or more machine-learning models (e.g., the first machine-learning model) to determine elements of the gameplay content that may be modified according to the one or more moderation parameters. The content moderation processor may receive audio input, video input, anticipated interactions (e.g., interactions with NPC, an opponent, tasks, missions, etc.), game themes, time period, game design style, any combination thereof, or the like. For example, the first machine-learning model may receive gameplay content of a particular game title and identify one or more elements of gameplay content that may be modified. In some examples, the one or more machine-learning models provisioned by the content moderation processor may receive input beyond the gameplay content. For example, the first machine-learning model may receive historical data pertaining to modified gameplay content in prior modification sessions. The first machine-learning model may reference the modified gameplay content while determining one or more elements of gameplay content to be moderated.

The content moderation processor may apply the moderation parameters to the one or more elements of gameplay content to be modified. The content moderation processor may provision a machine-learning model capable of content generation (e.g., the first machine-learning model) to modify the one or more elements of gameplay content. For example, the first machine-learning model may apply a moderation parameter (e.g., reduction of violence/gore) to one or more elements of gameplay content (e.g., a graphic violent image) and modify the one or more elements of gameplay content (e.g., reducing the visible blood and/or removing a graphic image from the user interface). The content moderation processor may generate moderated gameplay content and output the moderated gameplay content to the gameplay server (e.g., gameplay server 124 of FIGS. 1 and 2). The gameplay server may output the moderated gameplay content to the user device for display on a user interface. In some examples, the user interface may be a virtual reality interface.

FIG. 4B illustrates an exemplary user interface displaying a gameplay session in accordance with one embodiment. FIG. 4C illustrates an exemplary moderated user interface displaying a moderated gameplay session in accordance with one embodiment. As illustrated, user interface 412 may contain one or more elements of gameplay content (e.g., violent content, profanity of 420a and 422a, and a potentially alarming graphic of 426a) that may be modified by a content moderation processor (e.g., content moderation processor 114 described in FIG. 1). In some examples, the content moderation processor may generate modified or alternative images or displays to replace the one or more elements of gameplay content identified for moderation. For example, the content moderation processor may modify the profane image content from 420a, such that the character is wearing a censored or different shirt entirely. In another example, the content moderation processor may replace the scary monster in 426a (e.g., identified as associated with a certain scare level or rating) with a different object, such as a vase or a less scary monster (e.g., associated with a lower scare level or rating) as shown in 426b. As an additional example, the content moderation processor may replace text or audio of profane language, as shown in 422a, with substitute language as shown in 422b. The language may be text or may be spoken aloud by an NPC, another player, etc. In some examples, the content moderation processor may modify in-game audiovisual content associated with certain assigned content levels or ratings (e.g., associated with different age levels) by reducing the intensity, severity, or presence (e.g., partial or wholesale censorship) of the audiovisual content identified for moderation. Some gameplay content, such as a teddy bear as shown in 424a, may be identified as appropriate for general audiences of all age levels and thus allowed to remain unmodified by the content moderation processor. Moderated user interface 414 may display an unmodified version of the original gameplay content, as shown in 424b.

In some examples, as shown in moderated user interface 414, the content moderation processor may modify one or more elements of gameplay content from the virtual environment presented to the user device. For example, the content moderation processor may apply modifications, such as a “censoring” box, as shown in 420b, to block and/or redact the one or more elements of gameplay content. In some implementations of multiplayer content titles, such modifications may be applied to only a subset of the players participating in the session, while other players in the session may receive different presentations (including unmodified presentations) of the content within the virtual environment.

FIG. 4D illustrates an exemplary chat interface displaying a chat-based communication between one or more user devices. FIG. 4E illustrates an exemplary moderated chat interface displaying a moderated chat-based communication between one or more user devices. As illustrated, chat interface 418 may contain one or more messages transmitted between a first user device (e.g., messages 428a-b) and a second user device (e.g., message 430a-b) over the duration of a gameplay session. The second user device may be conducting a moderation session concurrently with the gameplay session. A content moderation processor (e.g., content moderation processor 114 described in FIG. 1) may receive input from the second user device containing the chat-based communications originating from the second user device (e.g., message 430a and all subsequent messages sent from the second user device). One or more machine-learning models (e.g., the machine-learning models described in FIG. 1) may generate one or more moderation parameters based on the chat-based communications (e.g., slang such as “spit on” and “skill issue,” abbreviations such as “sry” and “gg,” using the term “bro,” etc.). The one or more moderation parameters may be applied to chat interface 418, resulting in moderated chat interface 416.

For example, the profanity within message 428a output by the first user device may be moderated to alter the words within the message without altering the meaning and/or intent of the message (e.g., removing an unnecessary profane adjective, replacing a profane adjective with an appropriate adjective, etc.). In some examples, the profanity may be blocked and/or redacted from the second user device, as is shown in messages 432a and 432b. Message 432a contains a profane word, and message 432b has the profane word redacted from the message when displayed to the second user device.

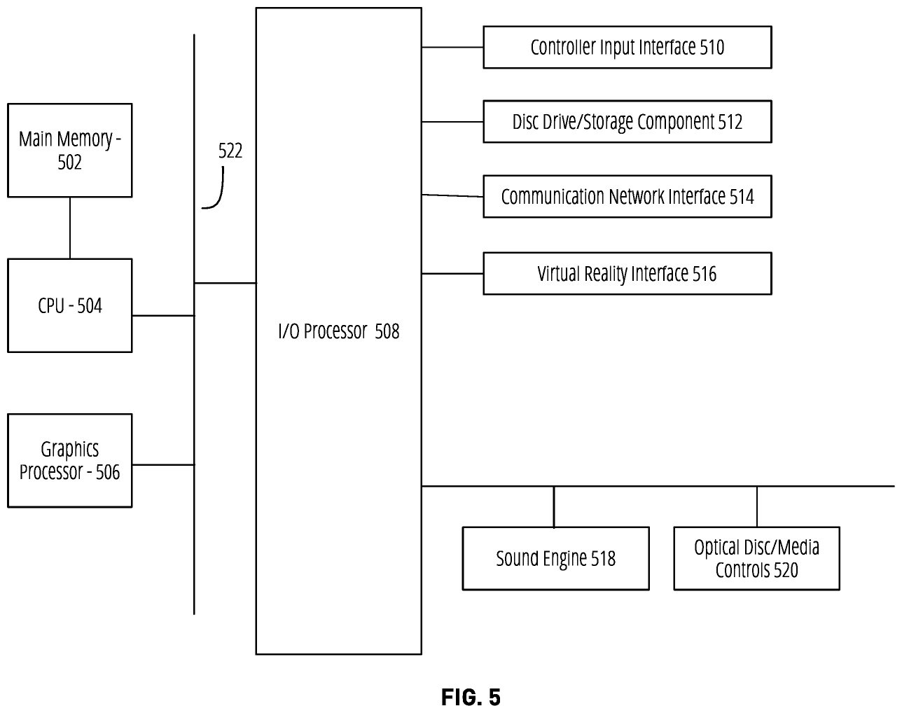

FIG. 5 illustrates a block diagram of an exemplary electronic entertainment system 500 in accordance with an embodiment of the presently disclosed invention. The electronic entertainment system 500 as illustrated in FIG. 5 includes a main memory 502, a central processing unit (CPU) 504, graphic processor 506, an input/output (I/O) processor 508, a controller input interface 510, a hard disc drive or other storage component 512 (which may be removable), a communication network interface 514, a virtual reality interface 516, sound engine 518, and optical disc/media controls 520. Each of the foregoing are connected via one or more system buses 522.

Electronic entertainment system 500 as shown in FIG. 5 may be an electronic game console. The electronic entertainment system 500 may alternatively be implemented as a general-purpose computer, a set-top box, a hand-held game device, a tablet computing device, or a mobile computing device or phone. Electronic entertainment systems may contain some or all of the disclosed components depending on a particular form factor, purpose, or design.

Main memory 502 stores instructions and data for execution by CPU 504. Main memory 502 can store executable code when the electronic entertainment system 500 is in operation. Main memory 502 of FIG. 5 may communicate with CPU 504 via a dedicated bus. Main memory 502 may provide pre-stored programs in addition to programs transferred through the I/O processor 508 from hard disc drive/storage component 512, a DVD or other optical disc (not shown) using the optical disc/media controls 520, or as might be downloaded via communication network interface 514.

The graphics processor 506 of FIG. 5 (or graphics card) executes graphics instructions received from the CPU 504 to produce images for display on a display device (not shown). The graphics processor 506 of FIG. 5 may transform objects from three-dimensional coordinates to two-dimensional coordinates, and vice versa. Graphics processor 506 may use ray tracing to aid in the rendering of light and shadows in a game scene by simulating and tracking individual rays of light produced by a source. Graphics processor 506 may utilize fast boot and load times, 4K-8K resolution, and up to 120 FPS with 120 hz refresh rates. Graphics processor 506 may render or otherwise process images differently for aspecific display device.

I/O processor 508 of FIG. 5 may also allow for the exchange of content over a wireless or other communications network (e.g., IEEE 802.x inclusive of Wi-Fi and Ethernet, 3G, 4G, LTE, and 5G mobile networks, and Bluetooth and short-range personal area networks). The I/O processor 508 of FIG. 5 primarily controls data exchanges between the various devices of the electronic entertainment system 500 including the CPU 504, the graphics processor 506, controller interface 510, hard disc drive/storage component 512, communication network interface 514, virtual reality interface 516, sound engine 518, and optical disc/media controls 520.

A user of the electronic entertainment system 500 of FIG. 5 provides instructions via a controller device communicatively coupled to the controller interface 510 to the CPU 504. A variety of different controllers may be used to receive the instructions, including handheld and sensor-based controllers (e.g., for capturing and interpreting eye-tracking-based, voice-based, and gestural commands). Controllers may receive instructions or input from the user, which may then be provided to controller interface 510 and then to CPU 504 for interpretation and execution. The instructions may further be used by the CPU 504 to control other components of electronic entertainment system 500. For example, the user may instruct the CPU 504 to store certain game information on the hard disc drive/storage component 512 or other non-transitory computer-readable storage media. A user may also instruct a character in a game to perform some specified action, which is rendered in conjunction with graphics processor 506, inclusive of audio interpreted by sound engine 518.

Hard disc drive/storage component 512 may include removable or non-removable non-volatile storage medium. Saud medium may be portable and inclusive of digital video disc, Blu-Ray, or USB coupled storage, to input and output data and code to and from the main memory 502. Software for implementing embodiments of the present invention may be stored on such a medium and input to the main memory via the hard disc drive/storage component 512. Software stored on hard disc drive 512 may also be managed by optical disk/media control 520 and/or communications network interface 514.

Communication network interface 514 may allow for communication via various communication networks, including local, proprietary networks and/or larger wide-area networks such as the Internet. The Internet is a broad network of interconnected computers and servers allowing for the transmission and exchange of Internet Protocol (IP) data between users connected through a network service provider. Examples of network service providers include public switched telephone networks, cable or fiber services, digital subscriber lines (DSL) or broadband, and satellite services. Communications network interface allows for communications and content to be exchanged between the various remote devices, including other electronic entertainment systems associated with other users and cloud-based databases, services and servers, and content hosting systems that might provide or facilitate game play and related content.

Virtual reality interface 516 allows for processing and rendering of virtual reality, augmented reality, and mixed reality data. This includes display devices such that might be partial or entirely immersive virtual environments. Virtual reality interface 516 may allow for exchange and presentation of immersive fields of view and foveated rendering in coordination with sounds processed by sound engine 518 and haptic feedback.

Sound engine 518 executes instructions to produce sound signals that are outputted to an audio device such as television speakers, controller speakers, stand-alone speakers, headphones or other head-mounted speakers. Different sets of sounds may be produced for each of the different sound output devices. This may include spatial or three-dimensional audio effects.

Optical disc/media controls 520 may be implemented with a magnetic disk drive or an optical disk drive for storing, managing, and controlling data and instructions for use by CPU 504. Optical disc/media controls 520 may be inclusive of system software (an operating system) for implementing embodiments of the present invention. That system may facilitate loading software into main memory 502.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

1. A computer-implemented method of content moderation, the method comprising:
receiving one or more audio segments sent over a communication network from a user device, wherein the audio segments include recorded communications associated with a user of the user device;
monitoring a gameplay session of the user device, wherein one or more gameplay interactions within a virtual environment are detected in the gameplay session;
generating one or more user inferences regarding an age of the user by applying a machine-learning model to the audio segments and the detected gameplay interactions, wherein the machine-learning model is trained to generate moderated gameplay content in accordance with the age of the user and decision-making within the gameplay session;
generating, via the machine-learning model, a set of moderation parameters relevant to the age of the user indicated by the user inferences; and
modifying content within the virtual environment of the gameplay session according to the set of moderation parameters that are relevant to the age of the user.

2. The computer-implemented method of claim 1, wherein the one or more user inferences include at least one of age, maturity level, demographic, geographic locality, culture, language, or diction.

3. The computer-implemented method of claim 1, wherein the one or more user inferences include at least one of an energy level, mood, emotional state, or mental state.

4. The computer-implemented method of claim 3, wherein the set of moderation parameters modify the virtual environment to counteract at least one of an energy level, mood, emotional state, or mental state.

5. The computer-implemented method of claim 1, wherein generating the user inferences further includes applying the machine-learning model to a user profile associated with the user.

6. The computer-implemented method of claim 1, wherein the machine-learning model is continually trained over time, and further comprising updating the set of moderation parameters after a threshold duration of time by applying the trained machine-learning model to updated user inferences.

7. The computer-implemented method of claim 1, wherein the set of moderation parameters includes instructions for at least one of language moderation, graphic content moderation, gameplay difficulty settings, or other gameplay moderation.

8. The computer-implemented method of claim 1, wherein the set of moderation parameters includes instructions for mimicking the user of the user device.

9. The computer-implemented method of claim 1, further comprising:
receiving feedback from the user that indicates one or more modifications to the user inferences; and
updating the set of moderation parameters based on the indicated modifications to the user inferences, wherein a subsequent gameplay session with the user device are moderated according to the modified set of moderation parameters.

10. The computer-implemented method of claim 1, further comprising:
storing the set of moderation parameters in memory; and
moderating future gameplay sessions according to the stored set of moderation parameters.

11. The computer-implemented method of claim 1, wherein modifying content within the virtual environment further comprises modifying one or more non-playable characters (NPCs) within the virtual environment according to the set of moderation parameters.

12. The computer-implemented method of claim 11, wherein modifying the one or more NPCs within the virtual environment includes at least one of modifying appearance, dialogue, or actions of the NPCs.

13. A computing apparatus comprising:
a communication interface that communicates over a communication network with a user device, wherein the communication interface receives one or more audio segments that include recorded communications associated with a user of the user device; and
a processor that executes instructions stored in memory, wherein the processor executes the instructions to:
monitor a gameplay session of the user device, wherein one or more gameplay interactions within a virtual environment are detected in the gameplay session;
generate one or more user inferences regarding an age of the user by applying a machine-learning model to the audio segments and the detected gameplay interactions, wherein the machine-learning model is trained to generate moderated gameplay content in accordance with the age of the user and decision-making within the gameplay session;
generate, via the machine-learning model, a set of moderation parameters relevant to the age of the user indicated by the user inferences; and
modify content within the virtual environment of the gameplay session according to the set of moderation parameters that are relevant to the age of the user.

14. The computing apparatus of claim 13, wherein the processor generates the user inferences by further applying the machine-learning model to a user profile associated with the user.

15. The computing apparatus of claim 13, wherein the machine-learning model is continually trained over time, and wherein the processor executes further instructions to update the set of moderation parameters after a threshold duration of time by applying the trained machine-learning model to updated user inferences.

16. The computing apparatus of claim 13, wherein the set of moderation parameters includes instructions for at least one of language moderation, graphic content moderation, gameplay difficulty settings, or other gameplay moderation.

17. The computing apparatus of claim 13, wherein the set of moderation parameters includes instructions for mimicking the user of the user device.

18. The computing apparatus of claim 13, wherein the processor executes further instructions to:
receive feedback from the user that indicates one or more modifications to the user inferences; and
update the set of moderation parameters based on the indicated modifications to the user inferences, wherein gameplay sessions with the user device are moderated according to the modified set of moderation parameters.

19. The computing apparatus of claim 13, further comprising memory that store the set of moderation parameters, wherein the processor executes further instructions to moderate future gameplay sessions according to the stored set of moderation parameters.

20. A non-transitory computer-readable storage medium, having embodied thereon instructions executable by a computer to perform a method for content moderation, the method comprising:
receiving one or more audio segments sent over a communication network from a user device, wherein the audio segments include recorded communications associated with a user of the user device;
monitoring a gameplay session of the user device, wherein one or more gameplay interactions within a virtual environment are detected in the gameplay session;
generating one or more inferences regarding an age of the user by applying a machine-learning model to the audio segments and the detected gameplay interactions, wherein the machine-learning model is trained to generate moderated gameplay content in accordance with the age of the user and decision-making within the gameplay session;
generating, via the machine-learning model, a set of moderation parameters relevant to the age of the user indicated by the user inferences; and
modifying content within the virtual environment of the gameplay session according to the set of moderation parameters that are relevant to the age of the user.
